(19) United States
(12) Patent Application Publication
(10) Pub. No.: US 2020/0262719 A1
(43) Pub. Date: Aug. 20, 2020

(54) IN SITU REMEDIATION OF PFAS-CONTAMINATED GROUNDWATER

(71) Applicant: Trustees of Tufts College, Medford, MA (US)

(72) Inventors: Kurt PENNELL, Waban, MA (US); Chen LIU, Medford, MA (US); Bonnie A. MARION, Somerville, MA (US); Matt F. SIMCIK, Stillwater, MN (US); William A. ARNOLD, Minnetonka, MN (US)

(21) Appl. No.: 16/645,026

(22) PCT Filed: Sep. 7, 2018
(86) PCT No.: PCT/US2018/049928

§ 371 Date: Mar. 6, 2020

Related U.S. Application Data
(60) Provisional application No. 62/555,885, filed on Sep. 8, 2017.

(51) Int. Cl. C02F 1/28; C02F 1/56; C02F 1/52; B09C 1/00

(52) U.S. Cl. CPC C02F 1/283; C02F 1/56; C02F 2101/36; B09C 1/002; C02F 1/5272

(57) ABSTRACT

An in situ remediation process for a PFAS-contaminated site includes sub-surface injection of slurry containing activated carbon in combination with a substances that promotes formation of an activated carbon emulsion and retention of PFAS by a solid matrix at said site, thereby removing said PFAS from groundwater.

This application claims the benefit of U.S. Provisional Application No. 62/555,885, filed Sep. 8, 2017, all of which is incorporated herein by reference.

### STATEMENT REGARDING FEDERALLY SPONSORED RESEARCH

This invention was made with government support under grant W912HQ-14-C-0042 awarded by the Department of Defense. The government has certain rights in the invention.

### FIELD OF INVENTION

The invention pertains to remedies for groundwater pollution and in particular to pollution by PFASs.

### BACKGROUND

Perfluoroalkyl and polyfluoroalkyl substances, collectively referred to herein as “PFASs,” both have a partially or fully fluorinated carbon chain and several different end groups including sulfonate, carboxylate, sulfonamidoalkyls, ethers and alcohols. The chain is typically a hydrophobic carbon-fluorine (CxFy) chain but with a polar head group, such as a sulfonate (SO3-), a carboxylate (COO—), alcohol (OH), or sulfonamide (SO2NH2). As a result, these substances tend to be amphiphilic.

Some of these substances, in particular those in which the end groups are sulfonates or carboxylates, have surface-active properties that make them particularly useful for extinguishing liquid-fuel fires. As such, these substances have found extensive use in mixtures of aqueous film-forming foams (AFFFs) as fire extinguishing agents. These varieties of PFASs have thus been released into the environment as part of firefighting and spill-response, both in actual emergencies and in fire-training activities by the military.

These substances are very stable and quite soluble in water. As a result, they are persistent in the environment and have the potential to travel long distances in aquifers. Both in vitro and in vivo studies, as well as epidemiologic studies, have linked PFAS exposure to a range of toxic effects to both humans and wildlife. Thus, their release into the environment and subsequent groundwater contamination is of serious concern and PFASs have become the focus of regulatory interest.

One strategy for in situ remediation of a pollutant is to transform it into something less harmful. This can be carried out through chemical or biological degradation processes (e.g., chemical oxidation or bioremediation).

Unfortunately, PFASs are extremely recalcitrant to most transformation processes. This recalcitrance arises in part as a result of the strength of the covalent bond between carbon and fluorine.

Other known ways of carrying out in situ remediation involve soil vapor extraction, thermal treatment, and air-sparging. These methods work best on volatile pollutants. However, PFASs are not particularly volatile and therefore not susceptible to such methods.

With no practical method of carrying out in situ remediation, the best current practice involves groundwater extraction followed by above-ground (ex situ) treatment (i.e., “pump-and-treat”) using conventional sorbents such as granular activated carbon (“GAC”). This method is effective for plume containment. But it does little to address the contaminant source. As a result, it typically requires prolonged treatment. Hence, there is critical need to develop novel technologies that can be applied in situ to effectively treat PFAS-contaminated groundwater.

Other known methods include directly treating drinking water with activated carbon, either in powdered or granulated form.

### SUMMARY

The invention features the use of a coagulant polymer in conjunction with powdered activated carbon (“PAC”) to sequester PFASs in situ.

In one aspect, the invention features a method for carrying out in situ remediation of a PFAS-contaminated site. Such a method includes carrying out subsurface injection of a slurry that contains activated carbon in combination with a substance that promotes formation of an activated carbon emulsion and retention of PFASs by a solid matrix at the site, thereby removing PFASs from groundwater and minimizing further subsurface mobility.

Practices of the invention include those in which the substance is a polymer coagulant, those in which it is polyDADMAC, and those in which it is a polyamine. In yet other embodiments, the slurry has 5,000 milligrams per liter of polyDADMAC and 1 gram per liter of activated carbon.

In another aspect, the invention features a slurry comprising activated carbon mixed with a coagulant polymer.

Embodiments of the slurry include those in which the coagulant polymer is polyDADMAC, and those in which it is a polyamine, and those in which it has 5,000 milligrams per liter of polyDADMAC and 1 gram per liter of activated carbon.

These and other features of the invention will be apparent from the following detailed description and the accompanying figures, in which:

### BRIEF DESCRIPTION OF THE FIGURES

FIG. 1 shows a site undergoing in situ remediation; and

FIG. 2 shows compares sequestration of a representative PFAS species (perfluorooctanoic acid, PFOA) onto porous media (Ottawa sand) with and without pre-injection of a slurry containing both activated carbon and a coagulant polymer.

### DETAILED DESCRIPTION

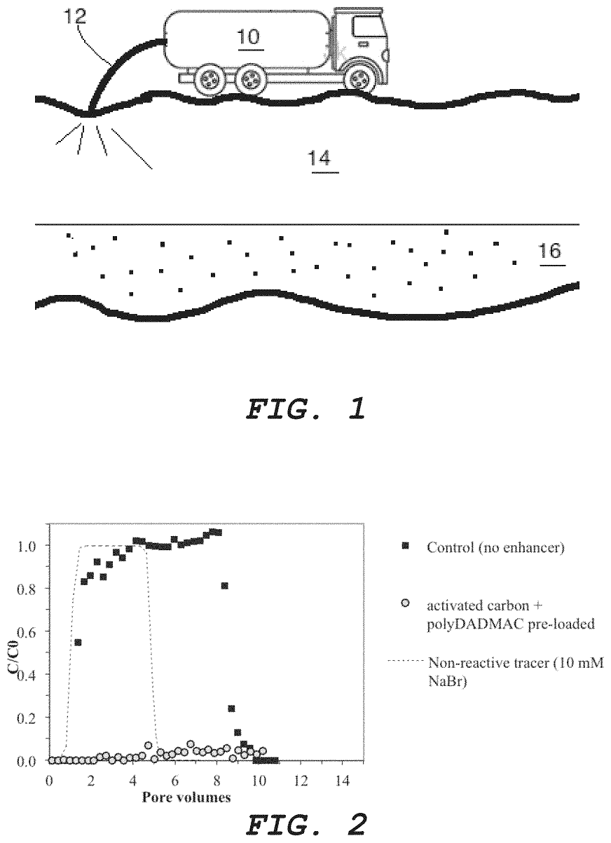

FIG. 1 shows a slurry-injector 10 injecting coagulating slurry 12 into a subsurface 14 above a water table 16 contaminated with PFASs. The coagulating slurry 12 includes powdered activated-carbon mixed with a coagulant polymer. A suitable coagulant polymer is polyDADMAC.

The presence of coagulant polymer creates a stable emulsion that allows the activated carbon to remain in suspension during injection. This contributes to the sorption and sequestration of PFASs.

To establish the effectiveness of the method, an Ottawa sand column was used to simulate groundwater flow through porous media. The sand was first saturated with 10 mM NaCl and then a slurry containing PAC and polyDADMAC was injected into the column. Results were compared to a control experiment where no PAC/polyDADMAC was injected. Next, simulated contaminated groundwater containing 50 ppb of PFAS, and in particular, with perfluorooctanoic acid (“PFOA”), hereafter referred to as the “pollutant,” was injected into the column. FIG. 2 shows a breakthrough curve of the pollutant, plotted as the measured PFOA concentration in effluent samples (C) divided by the influent concentration (C₀) versus time, expressed as dimensionless pore volumes (PVs).

For the column with no PAC/coagulant polymer, very little PFOA retention is observed, with pollutant breakthrough occurring just after 1 PV and reaching C/C₀. In contrast, the pre-injection of a slurry having both PAC and coagulant polymer promoted sequestration of the pollutant, with very little breakthrough (C/C₀ less than 0.1). In FIG. 2, it can be seen that the pre-injection of the PAC/coagulant polymer slurry results in as much as 95% greater removal of pollutant from the simulated groundwater than the activated carbon acting alone.

From the results shown in FIG. 2, it is possible to infer that PFAS is strongly adsorbed by the PAC that was retained within the column, and that the adsorbed coagulant could also form complexes with PFASs, further enhancing the sorption capacity of the PAC+coagulant treatment.

The relative amounts of coagulant polymer used and the manner of injection can be expected to vary depending on site-specific properties. However, the general principle of using a coagulant polymer to promote retention of the pollutant by solid matrix is expected to be applicable across multiple sites.

In the experimental results shown in FIG. 2, the coagulant polymer was polyDADMAC and 3.5 PVs of the slurry containing 5,000 milligrams per liter of polyDADMAC and 1 gram per liter of activated carbon was pre-injected. The PFOA pollutant was injected at a concentration of 50 micrograms per liter and at a flow rate of 0.12 milliliters per minute to simulate a pore water velocity of 1 meter per day. The dashed line shows the breakthrough of a non-reactive tracer made of 10 mM NaBr.

Although polyDADMAC is used in the above example, other coagulants made by used. One example is a polyamine coagulant, such as a co-polymer comprised of epichlorohydrin and dimethylamine.

Having described the invention, and a preferred embodiment thereof, what is claimed as new and secured by Letters Patent is:

1. A method comprising carrying out in situ remediation of a PFAS-contaminated site by carrying out sub-surface injection of a slurry that contains activated carbon in combination with a substance that promotes formation of an activated carbon emulsion and retention of PFAS by a solid matrix at said site, thereby removing said PFAS from groundwater.

2. The method of claim 1, further comprising selecting said substance to be a polymer coagulant.

3. The method of claim 1, further comprising selecting said substance to be polyDADMAC.

4. The method of claim 3, further comprising selecting said slurry to have a 5,000 milligrams per liter of polyDADMAC and 1 gram per liter of activated carbon.

5. The method of claim 1, further comprising selecting said substance to be polyamine.

6. A composition comprising a slurry, said slurry comprising activated carbon mixed a substance that promotes formation of an activated carbon emulsion and retention of PFAS by a solid matrix at said site, thereby preventing said PFAS from entering groundwater.

7. The composition of claim 6, wherein said substance comprises said substance comprises a polymer coagulant.

8. The composition of claim 6, wherein said substance comprises polyDADMAC.

9. The composition of claim 8, wherein said slurry has 5,000 milligrams per liter of polyDADMAC and 1 gram per liter of activated carbon.

10. The composition of claim 6, wherein said substance comprises polyamine.
